(19) United States
(12) Patent Application Publication
(10) Pub. No.: US 2008/0019363 A1
(43) Pub. Date: Jan. 24, 2008

(54) OPERATION AND ADMINISTRATION SYSTEM

(75) Inventor: Katsuya KITAJIMA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/782,298

(22) Filed: Jul. 24, 2007

(30) Foreign Application Priority Data
Jul. 24, 2006 (JP) 2006-200397

(51) Int. Cl. H04L 12/28

(52) U.S. Cl. 370/391

(57) ABSTRACT

An object of the present invention is to provide an operation and administration system that allows location of a failure in a network such as an Ethernet network. For this purpose, the operation and administration system of the present invention is characterized in that: a start point MEP unit 2A on a start point node 1A serving as the start point of an administered section transmits a link trace message (LTM) to an end point MEP unit 2D on an end point node 1D in a predetermined cycle; each of MIP units 3A to 3C existing on a transfer route of the LTM receives the LTM, and relays the LTM to the next node and also transmits a link trace reply (LTR) to the start point MEP unit 2A; the end point MEP unit 2D receives the LTM and transmits an LTR to the start point MEP unit 2A; the start point MEP unit 2A, upon receiving an LTR to the transmitted LTM, retrieves a piece of link trace information with a source ID indicating a source of the received LTR from a link trace DB having registered therein pieces of link trace information each including a source ID indicating a source of an LTR and a reception time of the LTR, and updates the reception time in the retrieved piece of link trace information to the current time.

This application is based upon and claims the benefit of priority from Japanese patent application No. 2006-200397, filed on Jul. 24, 2006, disclosure of which is incorporated herein in its entirety by reference.

### BACKGROUND OF THE INVENTION

The present invention pertains to operation and administration techniques in networks such as an Ethernet (registered trademark) network, and more particularly to an operation and administration technique that allows easy detection and location of a failure.

### DESCRIPTION OF RELATED ART

With the increasing importance of network systems as social infrastructures in today's advanced IT (Information Technology) society, stable running of network apparatuses providing services of the network systems is becoming important. For this purpose, various operation and administration techniques have been proposed.

An example of an operation and administration technique for detecting a failure is as follows. A start point node serving as the start point of an administered section transmits a monitoring packet to an end point node serving as the end point of the administered section via a monitoring port. The start point node then monitors for a response packet from the end point node for a predetermined time period. When a response packet from the end point node is received., the start point node checks a port via which the response packet is received. If the port is the same as the monitoring port via which the monitoring packet was transmitted, it is determined that the administered section is in a normal state, or otherwise in an abnormal state (e.g., see Japanese Patent Application Laid-Open No. 2004-134879 (document 1)).

An example of a known operation and administration technique for grasping a network topology is as follows. A check-requesting node designated by an operation system among nodes in a network transmits a configuration-check-requesting packet to an adjacent node. This configuration-check-requesting packet contains a count value indicating the number of communications between nodes. The node having received the configuration-check-requesting packet transmits it to one of its adjacent nodes that has not received the configuration-check-requesting packet. On this transmission, the count value contained in the configuration-check-requesting packet is incremented. Further, each node having received the configuration-check-requesting packet returns a response packet to the check-requesting node. This response packet contains the aforementioned count value, the address of the node itself, and the address of the adjacent node from which the configuration-check-requesting packet was transmitted. The check-requesting node analyzes the information contained in the response packet transmitted from each node and detects a network topology (e.g., see Japanese Patent Application Laid-Open No. 2005-328318 (document 2)).

The technique described in the document 1 has a problem that although the occurrence of a failure in an administered section is detected, a location of the failure cannot be specified because of the inability to grasp the network topology. On the other hand, the technique described in the document 2 has a problem that although the network topology can be grasped, a failure cannot be detected.

### SUMMARY OF THE INVENTION

An exemplary object of the invention is to provide an operation and administration system, a node, an operation and administration method, and a program in a computer-readable medium that allow location of a failure occurred in an administered section.

A first operation and administration system according to an exemplary aspect of the present invention is characterized in that

a start point node serving as a start point of an administered section includes:

a link trace database having registered therein pieces of link trace information each including a source ID indicating a source of a link trace reply and a reception time of the link trace reply; and

a start point termination function unit that transmits a link trace message to an end point termination function unit on an end point node serving as an end point of the administered section in a predetermined cycle and, upon receiving a link trace reply to the transmitted link trace message, performs processing of updating the reception time to a current time for a piece of link trace information with the source ID indicating a source of the received link trace reply among the pieces of link trace information registered in the link trace database,

each intermediate node existing on a transfer route of the link trace message from the start point node to the end point node includes

an intermediate function unit that transmits a link trace reply to the received link trace message to the start point termination function unit and transmits the received link trace message to a next node on the transfer route, and

the end point node includes

the end point termination function unit that transmits a link trace reply to the received link trace message to the start point termination function unit.

A second operation and administration system according to an exemplary aspect of the present invention is characterized in that

a network administration apparatus includes:

a link trace database having registered therein pieces of link trace information each including a source ID indicating a source of a link trace reply and a reception time of the link trace reply; and

a registration unit that, when link trace information including a source ID of a link trace reply and a reception time of the link trace reply is received from a start point termination function unit, processes a piece of link trace information with the same ID as the source ID in the received link trace reply among the pieces of link trace information registered in the link trace database to update the reception time to the reception time included in the received link trace information,

a start point node serving as a start point of an administered section includes

the start point termination function unit that transmits a link trace message to an end point termination function unit on an end point node serving as an end point of the administered section in a predetermined cycle and, upon receiving a link trace reply to the transmitted link trace message, transmits link trace information including a source ID and a reception time of the link trace reply to the network administration apparatus,

each intermediate node existing on a transfer route of the link trace message from the start point node to the end point node includes

an intermediate function unit that transmits a link trace reply to the received link trace message to the start point termination function unit and transmits the received link trace message to a next node on the transfer route, and

the end point node includes

the end point termination function unit that transmits a link trace reply to the received link trace message to the start point termination function unit.

A node according to an exemplary aspect of the present invention is a node serving as a start point of an administered section, characterized by comprising:

a link trace database having registered therein pieces of link trace information each including a source ID indicating a source of a link trace reply and a reception time of the link trace reply; and

a start point termination function unit that transmits a link trace message to an end point termination function unit on an end point node serving as an end point of the administered section in a predetermined cycle and, upon receiving a link trace reply to the transmitted link trace message from the end point termination function unit or an intermediate function unit provided in an intermediate node existing on a transfer route of the link trace message from the node itself to the end point node, performs processing of updating the reception time to a current time for a piece of link trace information with the source ID indicating a source of the received link trace reply among the pieces of link trace information registered in the link trace database.

An operation and administration method according to an exemplary aspect of the present invention is characterized by comprising the steps of:

transmitting a link trace message by a start point termination function unit on a start point node serving as a start point of an administered section to an end point termination function unit on an end point node serving as an end point of the administered section in a predetermined cycle;

transmitting, by an intermediate function unit provided in an intermediate node existing on a transfer route of the link trace message from the start point node to the end point node, a link trace reply to the received link trace message to the start point termination function unit;

transmitting the received link trace message by the intermediate function unit to a next node on the transfer route;

transmitting a link trace reply to the received link trace message by the end point termination function unit to the start point termination function unit; and

upon receiving a link trace reply to the transmitted link trace message, retrieving, by the start point termination function unit, a piece of link trace information with a source ID indicating a source of the link trace reply from a link trace database, and updating a reception time in the retrieved piece of link trace information to a current time, the link trace database having stored therein pieces of link trace information each including a source ID indicating a source of a link trace reply and a reception time of the link trace reply.

A program in a computer-readable medium according to an exemplary aspect of the present invention causing a computer provided with a link trace database having registered therein pieces of link trace information each including a source ID indicating a source of a link trace reply and a reception time of the link trace reply to function as

a start point termination function unit that transmits a link trace message to an end point termination function unit on an end point node serving as an end point of an administered section in a predetermined cycle and, upon receiving a link trace reply to the transmitted link trace message from the end point termination function unit or an intermediate function unit provided in an intermediate node existing on a transfer route of the link trace message, performs processing of updating the reception time to a current time for a piece of link trace information with the source ID indicating a source of the received link trace reply among the pieces of link trace information registered in the link trace database.

### BRIEF DESCRIPTION OF THE DRAWINGS

The objects and features of the present invention will become more apparent from the consideration of the following detailed description taken in conjunction with accompanying drawings, in which:

FIG. 1 is a diagram showing an administered section K of an operation and administration system;

FIG. 2 is a block diagram showing a simplified configuration of a node existing in the administered section K;

FIG. 3 is a block diagram showing an exemplary configuration of a node 1A;

FIG. 4 is a diagram showing an exemplary administration information entry screen;

FIG. 5 is a diagram showing exemplary content of an administration information storage unit 121;

FIG. 6 is a diagram showing exemplary content of a link trace database 123;

FIG. 7 is a block diagram showing an exemplary configuration of a start point MEP unit 2A;

FIG. 8 is a diagram showing an exemplary link trace message;

FIG. 9 is a diagram showing an exemplary configuration of a MIP unit 3A;

FIG. 10 is a diagram showing an exemplary link trace reply;

FIG. 11 is a flowchart showing exemplary processing in registration means 11;

FIG. 12 is a flowchart showing exemplary processing in link trace message transmission means 21;

FIG. 13 is a flowchart showing exemplary processing in link trace reply transmission means 31;

FIG. 14 is a flowchart showing exemplary processing in a relay means 32;

FIG. 15 is a diagram showing an exemplary link trace reply;

FIG. 16 is a flowchart showing exemplary processing in link trace reply reception means 23;

FIG. 17 is a flowchart showing exemplary processing in link trace information analysis means 25;

FIG. 18 is a diagram showing a state on the occurrence of a failure in the administered section K;

FIG. 19 is a diagram showing exemplary content of the link trace database 123 on the occurrence of the failure in the administered section K;

FIG. 20 is a block diagram showing an exemplary configuration of the operation and administration system;

FIG. 21 is a block diagram showing an exemplary configuration of a start point MEP unit 2Aa; and

FIG. 22 is a block diagram showing an exemplary configuration of a network administration apparatus 5.

### DESCRIPTION OF EXEMPLARY EMBODIMENTS

The following embodiments are characterized in that a database function for facilitating failure check is added to a link trace function, which is one of Ethernet (registered trademark) OAM functions, i.e., OAM (Operation, Administration and Maintenance) functions implemented in Ethernet networks. The Ethernet OAM functions are recommended in ITU-T Y.1731 (OAM Functions and Mechanisms for Ethernet based Networks).

### First Exemplary Embodiment

### <Configuration>

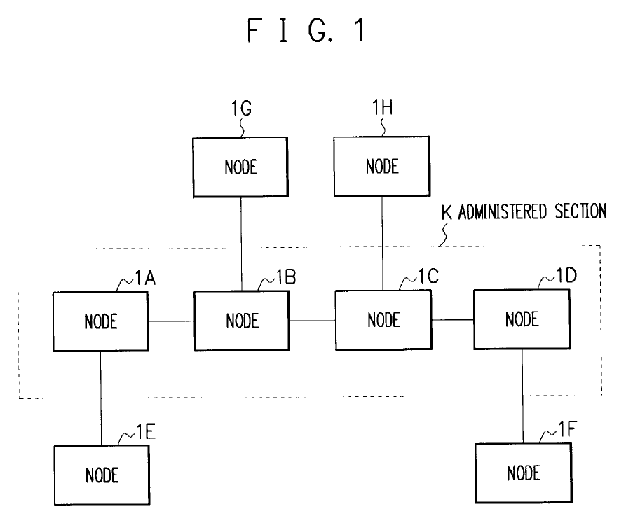

Referring to FIG. 1, an Ethernet network is shown including a plurality of nodes 1A to 1H. A section from the node 1A to the node 1D is an administered section K administered by an operation and administration system. In this exemplary embodiment, the nodes 1A to 1H are based on layer 2 Ethernet switching.

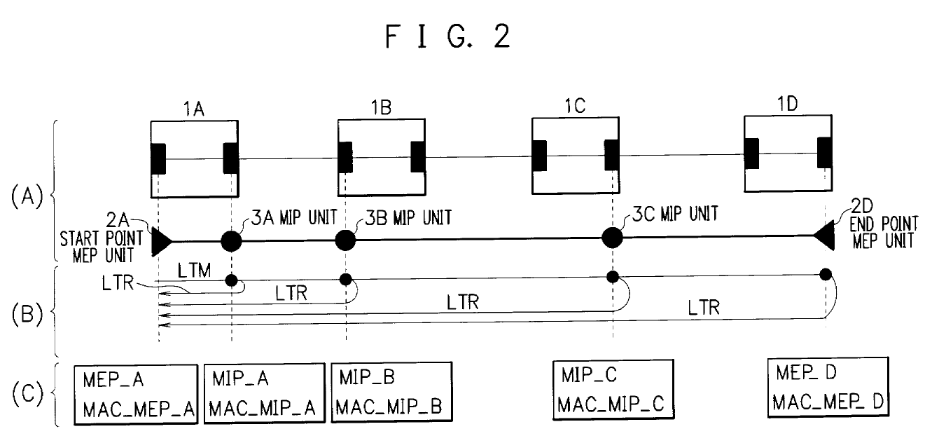

Referring to FIG. 2(A), a start point termination function unit (a start point MEP (Maintenance Entity Group End Point) unit) 2A is provided in the node 1A serving as the start point of the administered section K (which may be referred to as a start point node). Also, an end point termination function unit (an end point MEP unit) 2D is provided in the node 1D serving as the end point of the administered section K (which may be referred to as an end point node). Intermediate function units (MIP (Maintenance Entity Group Intermediate Point) units) may be provided between the start point MEP unit 2A and the end point MEP unit 2D. In this embodiment, MIP units 3A to 3C are provided on the nodes 1A to 1C respectively. The IDs and the MAC addresses of the start point MEP unit 2A and the end point MEP unit 2D are “MEP A and MEP D” and “MAC MEP A and MAC MEP D” as shown in FIG. 2(C). The IDs and the MAC addresses of the MIP units 3A to 3C are “MIP A, MIP B, and MIP C” and “MAC MIP A, MAC MIP B, and MAC MIP C” as shown in FIG. 2(C).

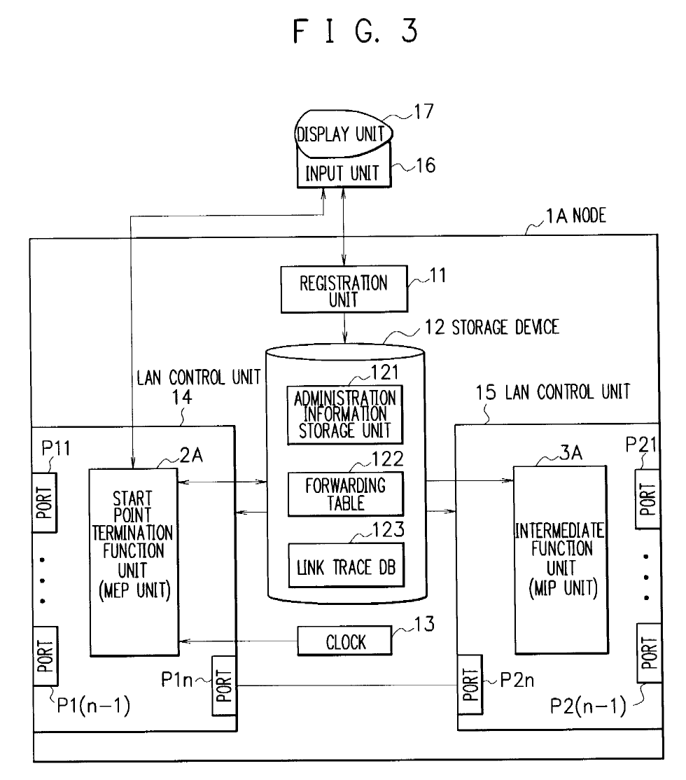

Referring to FIG. 3, the start point node 1A includes a registration unit 11, a storage device 12, a clock 13, LAN (Local Area Network) control units 14 and 15, an input unit 16 such as a keyboard, and a display unit 17 such as an LCD.

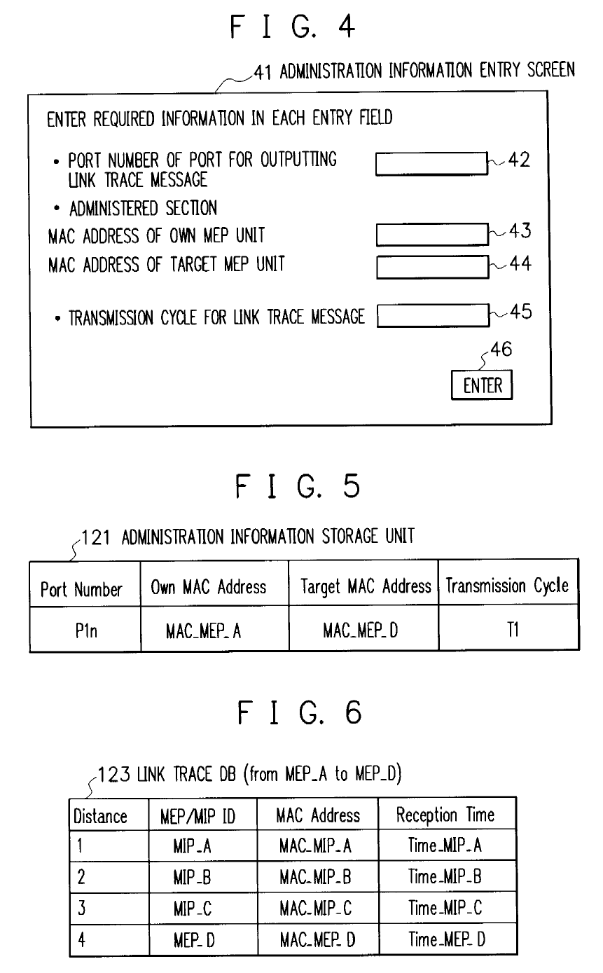

The registration unit 11 has a function of displaying an administration information entry screen 41 as shown in FIG. 4 on the display unit 17, and a function of registering in the storage device 12 administration information that is entered by an administrator through the administration information entry screen 41. The administration information entry screen 41 shown in FIG. 4 includes an entry field 42 for a port number of a port from which a link trace message (LTM) is output, an entry field 43 for the MAC address of the start point MEP unit 2A, an entry field 44 for the MAC address of the end point MEP unit 2D, an entry field 45 for a transmission cycle for the link trace message, and an enter button 46.

The storage device 12 includes an administration information storage unit 121, a forwarding table 122, and a link trace database (DB) 123.

The administration information is registered by the registration unit 11 in the administration information storage unit 121. FIG. 5 is a diagram showing exemplary content of the administration information storage unit 121. The example shown indicates that the port number of the port from which the link trace message is output is “P1n”, the MAC address of the start point MEP unit 2A is “MAC MEP A”, the MAC address of the end point MEP unit 2D is “MAC MEP D”, and the transmission cycle for the link trace message is “T1”.

The forwarding table 122 is a table for determining an output port for a packet.

Link trace information is registered in the link trace database 123, including the distance (the number of hops) between the start point MEP unit 2A and a source of a link trace reply (LTR), the ID and the MAC address of the source of the link trace reply, and the reception time of the link trace reply. FIG. 6 is a diagram showing example of the content of the link trace database 123. In the example shown, the first piece of link trace information indicates that a link trace reply transmitted from the MIP unit 3A having the ID “MIP A” and the MAC address “MAC MIP A” was received at the time “Time MIP A”, and that the distance to the MIP unit 3A is “1”.

The clock 13 shows the current time.

The LAN control unit 14 includes the start point MEP unit 2A. When a link trace reply is received via one of ports P11 to P1n, the LAN control unit 14 passes it to the start point MEP unit 2A. When a packet other than a link trace reply is received, the LAN control unit 14 determines an output port based on the forwarding table 122 and outputs the packet from that port.

The LAN control unit 15 includes the MIP unit 3A. When a link trace message or a link trace reply is received from one of ports P21 to P2n, the LAN control unit 15 passes it to the MIP unit 3A. When a packet other than a link trace message or a link trace reply is received, the LAN control unit 15 determines an output port based on the forwarding table 122 and outputs the packet from that port. For the LAN control unit without the MIP unit or the MEP unit, when a link trace message or a link trace reply is received, the LAN control unit determines an output port based on its destination MAC address and the content of the forwarding table and transmits the link trace message or the link trace reply from that port.

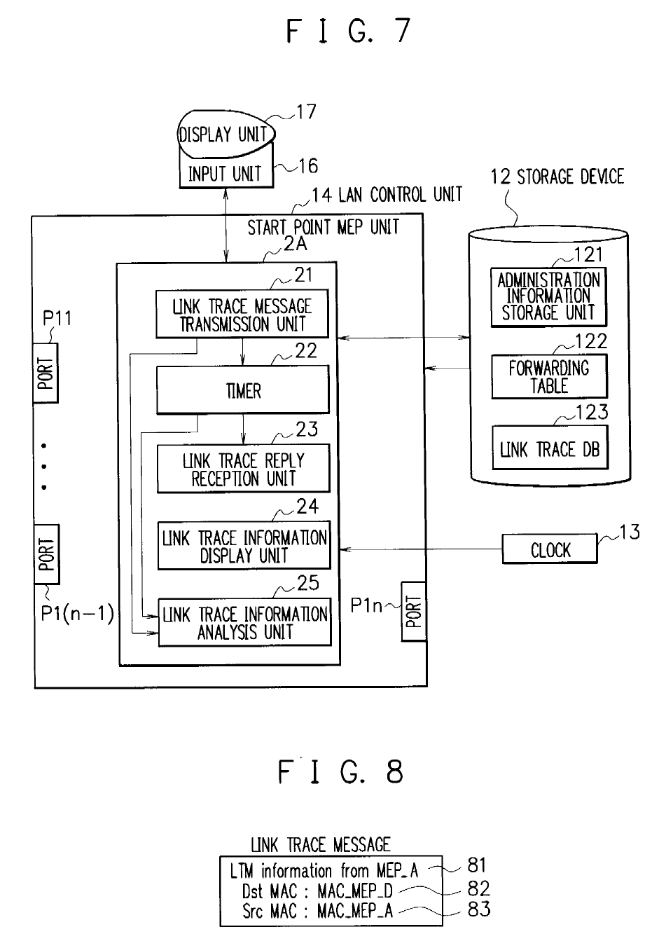

Referring to FIG. 7, the start point MEP unit 2A includes a link trace message transmission unit 21, a timer 22, a link trace reply reception unit 23, a link trace information display unit 24, and a link trace information analysis unit 25. In FIG. 7, elements given the same symbols as in FIG. 3 represent like elements.

The link trace message transmission unit 21 has a function of transmitting a link trace message via the port of the port number registered in the administration information storage unit 121 in the transmission cycle T1 registered in the administration information storage unit 121, and a function of starting the timer 22 and activating the link trace information analysis unit 25 after transmitting the link trace message.

FIG. 8 is a diagram showing an exemplary link trace message. The link trace message contains information 81 indicating that this is a link trace message, a destination MAC address 82, and a source MAC address 83. The link trace message transmission unit 21 sets the destination MAC address 82 to the MAC address of the end point MEP unit 2D, and the source MAC address to the MAC address of the start point MEP unit 2A.

The timer 22 is provided for showing the period of validity for link trace replies. The timer 22 sets a timeout signal to “0” upon being started by the link trace message transmission unit 21. Thereafter, the timer 22 times out and sets the timeout signal to “1” upon a lapse of predetermined time T2.

This predetermined time T2 is set shorter than the transmission cycle T1 for the link trace message.

When the timeout signal output from the timer 22 is “1”, the link trace reply reception unit 23 discards a link trace reply passed from the LAN control unit 14. When the timeout signal is “0”, the link trace reply reception unit 23 registers the link trace information according to a link trace reply passed from the LAN control unit 14 in the link trace database 123.

The link trace information display unit 24 displays the content of the link trace database 123 on the display unit 17.

The link trace information analysis unit 25 performs processing of detecting and locating a failure based on the link trace information registered in the link trace database 123.

The start point MEP unit 2A having these functions may be implemented by a computer (CPU), for example in the following manner. A disk, semiconductor memory, or other recording media records thereon a program for causing a computer to function as the start point MEP unit 2A. The computer controls its operation according to the program to implement the link trace message transmission unit 21, the timer 22, the link trace reply reception unit 23, the link trace information display unit 24, and the link trace information analysis unit 25 on the computer.

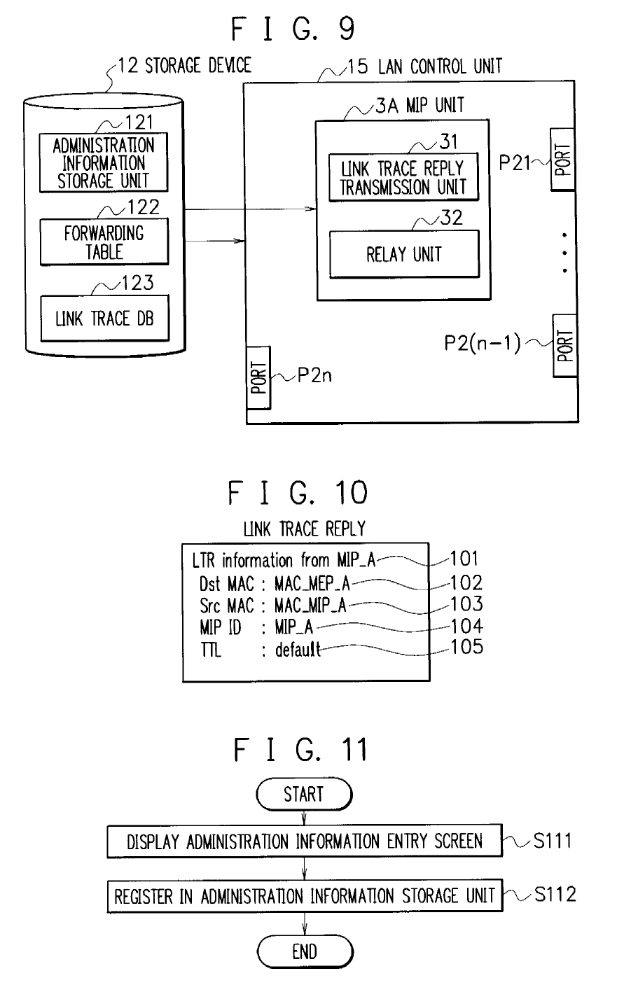

Referring to FIG. 9, the MIP unit 3A includes a link trace reply transmission unit 31 and a relay unit 32.

When a link trace message is passed from the LAN control unit 15, the link trace reply transmission unit 31 transmits a link trace reply to the start point MEP unit 2A that has transmitted the link trace message.

FIG. 10 is a diagram showing an exemplary link trace reply. The link trace reply contains information 101 indicating that this is a link trace reply, a destination MAC address 102, a source MAC address 103, a source ID 104, and TTL (Time To Live) 105. The link trace reply transmission unit 31 sets the destination MAC address 102 to the MAC address “MAC MEP A” of the start point MEP unit 2A, and the destination MAC address 103 and the ID 104 to the MAC address “MAC MIP A” and the ID “MIP A” of its own MIP unit 3A. The TTL 105 is set to a default value.

When a link trace message is passed from the LAN control unit 15, the relay unit 32 determines an output port for the link trace message based on the destination MAC address in the message and the content of the forwarding table 122 and outputs the link trace message from that port. When a link trace reply is passed from the LAN control unit 15, the relay unit 32 decrements the contained TTL by one. The relay unit 32 then determines an output port for the link trace reply based on the destination MAC address and the content of the forwarding table 122 and outputs the link trace reply from that port.

The MIP unit 3A having these functions may be implemented by a computer (CPU), for example in the following manner. A disk, semiconductor memory, or other recording media records thereon a program for causing a computer to function as the MIP unit 3A. The computer controls its operation according to the program to implement the link trace reply transmission unit 31 and the relay unit 32 on the computer.

The MIP units 3B and 3C provided on the nodes 1B and 1C also have the same configuration as the MIP unit 3A, and the end point MEP unit 2D provided on the node 1D has the configuration of the MIP unit 3A shown in FIG. 9 with the relay unit 32 eliminated therefrom. The end point MEP unit 2D and the MIP units 3B and 3C may also be implemented by a computer (CPU).

### <Operations>

Now, operations will be described in detail.

Once the administrator determines the administrated section K as in FIG. 1, the administrator activates the registration unit 11 in the start point node 1A of the administered section K. This causes the registration unit 11 to display the administration information entry screen 41 as shown in FIG. 4 on the display unit 17 (step S111 in FIG. 11). When the administration information entry screen 41 is displayed, the administrator enters required information in the entry fields 42 to 45 and then operates the enter button 46. This causes the registration unit 11 to register the information entered in the entry fields 42 to 45 in the administration information storage unit 121 (step S112). For example, if the port number “P1n” of the port P1n is entered in the entry field 42, the MAC address “MAC MEP A” of the start point MEP unit 2A is entered in the entry field 43, the MAC address “MAC MEP D” of the end point MEP unit 2D is entered in the entry field 44, and the transmission cycle “T1” is entered in the entry field 45, then the content of the administration information storage unit 121 will be as shown in FIG. 5.

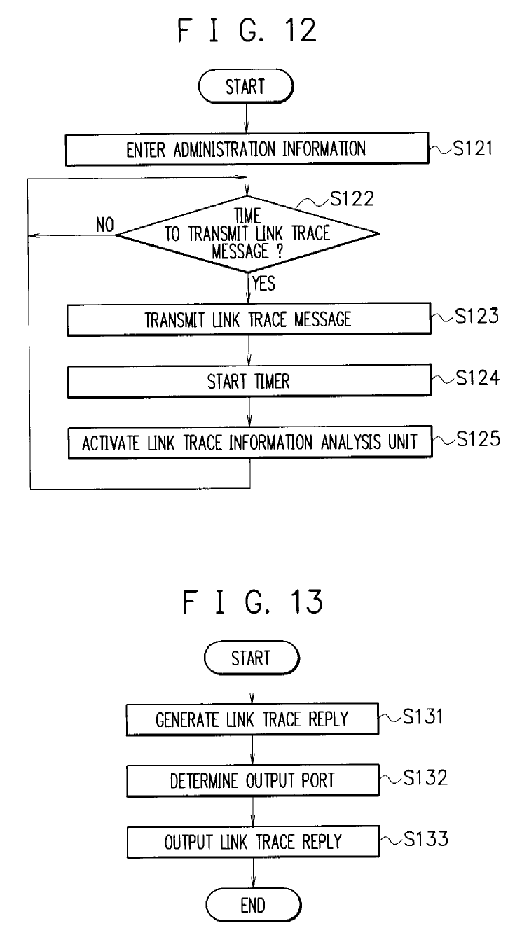

The administrator then activates the start point MEP unit 2A in the start point node 1A. This causes the link trace message transmission unit 21 in the start point MEP unit 2A to perform processing shown in a flowchart of FIG. 12.

First, the link trace message transmission unit 21 inputs the administration information shown in FIG. 5 from the administration information storage unit 121 (step S121). The link trace message transmission unit 21 then waits for the time to transmit a link trace message (step S122). That is, the unit 21 waits until the time corresponding to the transmission cycle T1 set in the administration information passes.

When the time to transmit a link trace message comes (YES in step S122), the link trace message transmission unit 21 outputs a link trace message from the port P1n corresponding to the port number “P1n” in the administration information (step S123). The link trace message has the destination MAC address 82 set to the target MAC address “MAC MEP D” in the administration information, and the source MAC address set to its own MAC address “MAC MEP A” in the administration information, as shown in FIG. 8. The link trace message transmission unit 21 then starts the timer 22 and activates the link trace information analysis unit 25 (steps S124 and S125) and repeats the processing of step S121.

The link trace message output from the port P1n in step S123 is transmitted to the port P2n of the LAN control unit 15. The LAN control unit 15 receives the link trace message and passes the message to the MIP unit 3A.

Once the link trace message shown in FIG. 8 is passed, the link trace reply transmission unit 31 in the MIP unit 3A first generates a link trace reply as shown in FIG. 10 (step S131 in FIG. 13). That is, it generates a link trace reply in which the destination MAC 102 is set to the source MAC address “MAC MEP A” in the link trace message, the source MAC address 103 and the source ID 104 are set to the MAC address “MAC MIP A” and the ID “MIP A” of its own MIP unit 3A, and the TTL 105 is set to a predefined value.

The link trace reply transmission unit 31 then determines a port for outputting the link trace reply based on the destination MAC address “MAC MEP A” in the link trace reply generated in step S131 and the content of the forwarding table 122 (in this example, it will be the port P2n) and outputs the link trace reply from the port P2n (steps S132 and S133). Thus, as shown in FIG. 2(B), the link trace reply is transmitted from the MIP unit 3A to the start point MEP unit 2A.

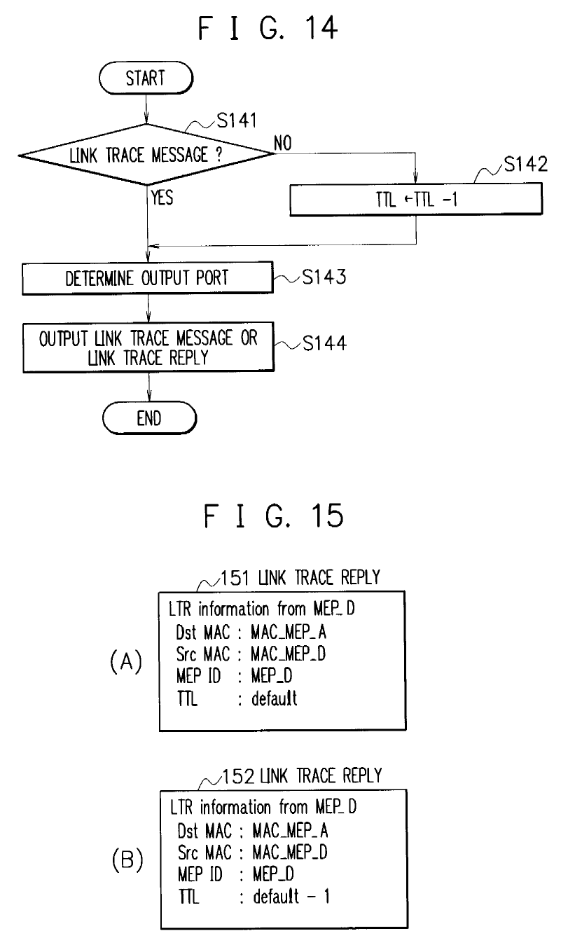

On the other hand, as shown in a flowchart in FIG. 14, once the link trace message as shown in FIG. 8 is passed from the LAN control unit 15 (YES in step S141), the relay unit 32 in the MIP unit 3A determines an output port for the link trace message based on the destination MAC address “MAC MEP D” in the message and the content of the forwarding table 122 and outputs the link trace message from that port (steps S143 and S144). Thus, as shown in FIG. 2(B), the link trace message is transmitted from the MIP unit 3A to the MIP unit 3B.

Similar processing as in the MIP unit 3A is performed in the MIP unit 3B, so that a link trace reply is transmitted to the MIP unit 3A and the link trace message is transmitted to the MIP unit 3C as shown in FIG. 2(B). Further, similar processing is performed in the MIP unit 3C, so that a link trace reply is transmitted to the MIP unit 3B and the link trace message is transmitted to the end point MEP unit 2D.

Once receiving the link trace message, the end point MEP unit 2D performs the processing shown in the flowchart of FIG. 13. First, in step S131, a link trace reply 151 as shown in FIG. 15(A) is generated. In step S132, an output port for the link trace reply is determined based on the destination MAC address “MAC MEP A” in the link trace reply and the content of the forwarding table (not shown). In step S133, the link trace reply generated in step S131 is transmitted from the port determined in step S132.

The link trace reply 151 transmitted from the end point MEP unit 2D is received at the LAN control unit of the node 1C. The LAN control unit passes the received link trace reply to the MIP unit 3C.

The MIP unit 3C has the same configuration as the MIP unit 3A. Once the link trace reply 151 is passed (NO in step S141 in FIG. 14), the relay unit (not shown) in the MIP unit 3C generates a link trace reply 152 as shown in FIG. 15(B) by decrementing the TTL in the link trace reply 151 by one (step S142). The relay unit then determines an output port based on the destination MAC address “MAC MEP A” in the link trace reply 152 and the content of the forwarding table and outputs the link trace reply 152 from that port (steps S143 and S144).

The link trace reply 152 output from the MIP unit 3C is transmitted to the start point MEP unit 2A via the MIP unit 3B and the MIP unit 3A. It is noted that in the MIP units 3A and 3B, similar processing as in the MIP unit 3C is performed to decrement the TTL in the link trace reply by one.

The LAN control unit 14 in the start point node 1A including the start point MEP unit 2A receives the link trace reply and passes the reply to the start point MEP unit 2A.

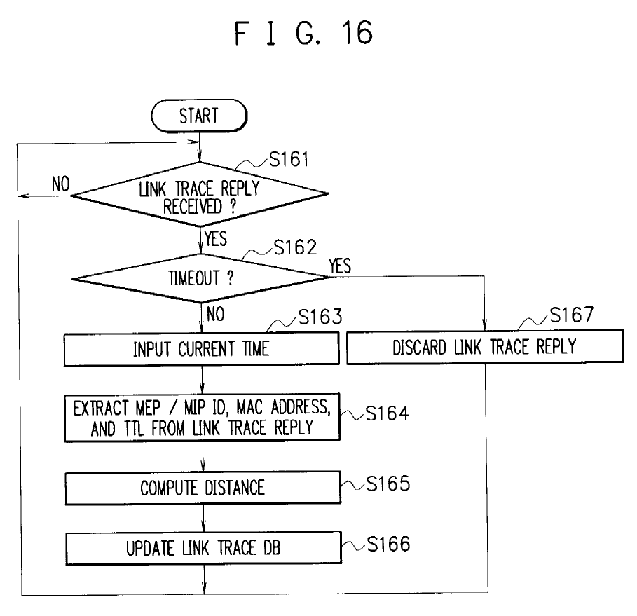

As shown in a flowchart of FIG. 16, once the link trace reply is passed from the LAN control unit 14 (YES in step S161), the link trace reply reception unit 23 in the start point MEP unit 2A determines whether or not the timer 22 has timed out based on the timeout signal output from the timer 22 (step S162).

If the timer 22 has timed out (YES in step S162), it is determined that the link trace reply passed from the LAN control unit 14 is invalid, so that the link trace reply is discarded (step S167).

If the timer 22 has not timed out (NO in step S162), processing in steps S163 to S166 is performed.

In step S163, the current time is input from the clock 13. In step S164, the ID and the MAC address of the source and the TTL are extracted from the link trace reply. In step S165, the distance (the number of hops) to the source of the link trace reply is computed based on the TTL.

In step S166, the following processing is performed. First, it is checked whether link trace information with the same ID as the ID extracted in step S164 is registered in the link trace database 123. If such link trace information is not registered, link trace information including the current time input in step S163 (i.e., the reception time of the link trace reply), the ID and the MAC address extracted in step S164, and the distance computed in step S165 is generated and additionally registered in the link trace database 123. If link trace information with the same ID as the ID extracted in step S164 is registered, the reception time in that link trace information is replaced with the current time input in step S163 and the distance is replaced with the distance computed in step S165. This is the processing performed in step S166.

When the processing in step S166 or S167 is finished, the link trace reply reception unit 23 returns to step S161 to wait for a link trace reply to be passed from the LAN control unit 14.

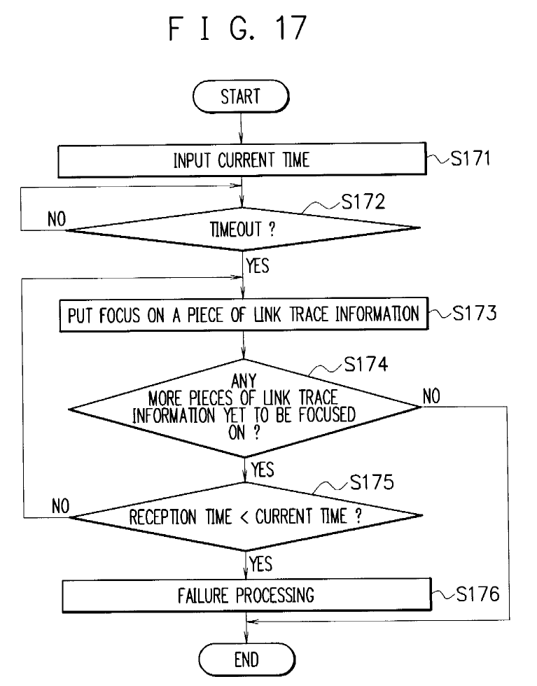

On the other hand, the link trace information analysis unit 25 in the start point MEP unit 2A, when activated by the link trace message transmission unit 21 in transmission of the link trace message (step S125 in FIG. 12), first inputs the current time from the clock 13 (step S171 in FIG. 17). The link trace message analysis unit 25 then waits for a timeout of the timer 22 (step S172). That is, in step S172, the unit 25 waits until the period of validity passes for link trace replies to the link trace message transmitted by the link trace message transmission unit 21.

Upon a timeout of the timer 22 (YES in step S172), the link trace information analysis unit 25 puts the focus on a piece of link trace information stored in the link trace database 123 (step S173). Here, the link trace information analysis unit 25 puts the focus on a piece of link trace information with the smallest value of the item “distance” among pieces of link trace information yet to be focused on.

The link trace information analysis unit 25 then compares the reception time in the piece of link trace information in focus to the current time input in step S171 (step S175).

If the reception time is earlier than the current time (YES in step S175), it is determined that a failure has occurred in the administered section K. Failure processing is performed (step S176), and then the processing is terminated. If the reception time is equal to or later than the current time (NO in step S175), the process returns to step S173 to put the focus on the next piece of link trace information. When there are no more pieces of link trace information yet to be focused on (NO in step S174), the link trace information analysis unit 25 terminates the processing.

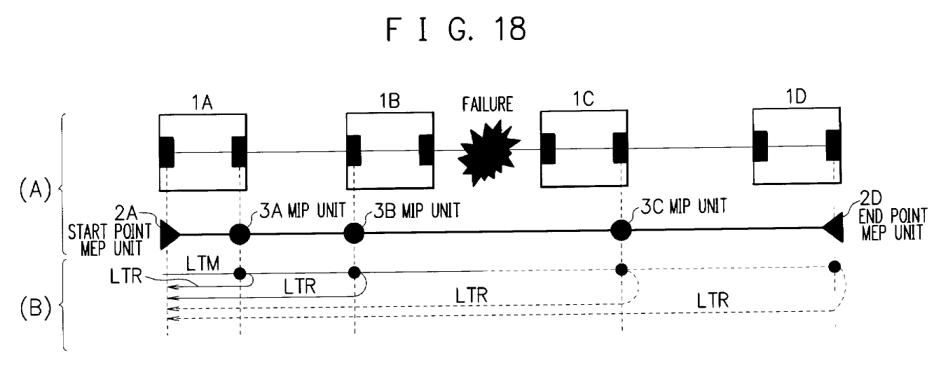

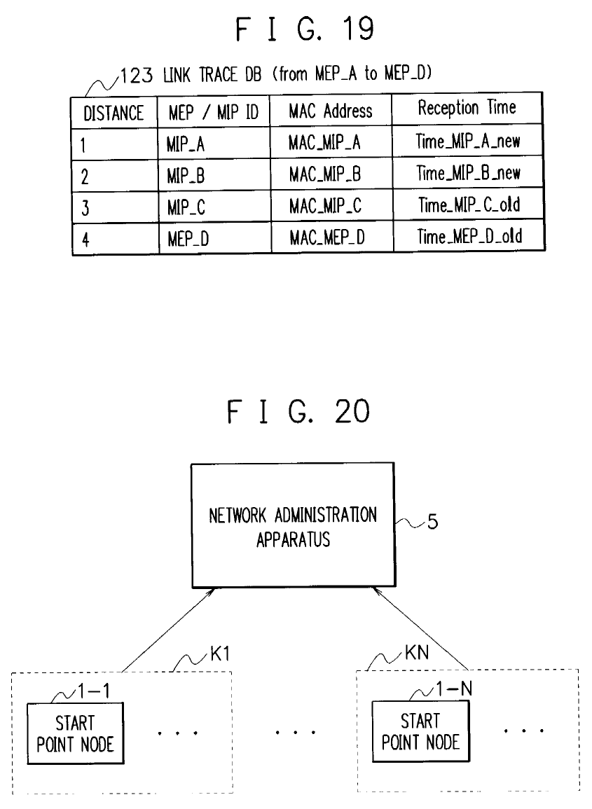

Here, if the administered section K is in a normal state as shown in FIG. 2(A), the link trace replies are returned from all MIP units 3A to 3C and the end point MEP unit 2D to the start point MEP unit 2A as shown in FIG. 2(B) and the reception times in the link trace information registered in the link trace database 123 are updated. Therefore, the determination in step S175 never results in YES. However, if a failure has occurred between the node 1B and the node 1C as shown in FIG. 18(A) for example, the link trace replies from the MIP unit 3C and the end point MEP unit 2D do not arrive at the start point MEP unit 2A as shown in FIG. 18(B). As shown in FIG. 19, in the link trace information registered in the link trace database 123, the reception times in the link trace information about the MIP units 3A and 3B are updated while the reception times in the link trace information about the MIP unit 3C and the end point MEP unit 2D are not updated. Therefore, the determination in step S175 results in YES when a failure has occurred in the administered section K.

The failure processing performed in step S176 will be described here. In step S176, first it is checked whether or not the distance in the piece of link trace information being in focus when the determination in step S175 results in YES is “1”.

If the distance is “1”, it is determined that a failure has occurred between the start point MEP unit 2A and the MIP unit 3A identified from the ID in the piece of link trace information in focus. A notification of the occurrence of the failure between the start point MEP unit 2A and the MIP unit 3A is displayed on the display unit 17.

If the distance in the piece of link trace information being in focus when the determination in step S175 results in YES is not “1”, it is determined that a failure has occurred between a MIP unit or the end point MEP unit identified from the ID in the piece of link trace information in focus unit and a MIP unit identified from the ID in a piece of link trace information with the distance smaller by one than the former piece of link trace information. A notification thereof is displayed on the display unit 17.

For example, if the content of the link trace database 123 is as shown in FIG. 19, a piece of link trace information with the distance “3” is the piece of link trace information being in focus when the step S175 results in YES. Therefore, the link trace information analysis unit 25 determines that a failure has occurred between the MIP unit 3C identified from the ID “MIP C” in this piece of link trace information and the MIP unit 3B identified from the ID “MIP B” in a piece of link trace information with the distance smaller by one than the former link trace information. The link trace information analysis unit 25 displays a notification of the occurrence of the failure between the MIP unit 3B and the MIP unit 3C on the display unit 17.

### <Advantages>

This exemplary embodiment locates a failure occurred in an administered section. It further provides an advantage to determine the time of the occurrence of the failure. This is because the start point node 1A serving as the start point of the administered section K includes: the link trace database 123 having registered therein pieces of link trace information each including a source ID indicating a source of a link trace reply and a reception time of the link trace reply; and the start point termination function unit 2A that transmits a link trace message to the end point termination function unit 2D on the end point node 1D serving as the end point of the administered section K in a predetermined cycle and, upon receiving a link trace reply to this link trace message, performs processing of updating the reception time to the current time for a piece of link trace information with its source ID indicating a source of the received link trace reply among the pieces of link trace information registered in the link trace database 123.

Further, this embodiment provides an advantage that an administrator easily recognizes where a failure has occurred. This is because the link trace information analysis unit 25 is provided that determines the occurrence of a failure between an intermediate function unit or the end point termination function unit identified from a source ID in a piece of link trace information with the shortest distance among pieces of link trace information with their reception times earlier than the transmission time of the link trace message, and an intermediate function unit identified from a source ID in a piece of link trace information with the longest distance among pieces of link trace information with their reception times later than the above transmission time.

### Second Exemplary Embodiment

Now, a second exemplary embodiment of the operation and administration system will be described. In the first exemplary embodiment, the link trace database is provided in the node that includes the start point MEP unit. The second exemplary embodiment is characterized in that the link trace database is provided in a network administration apparatus.

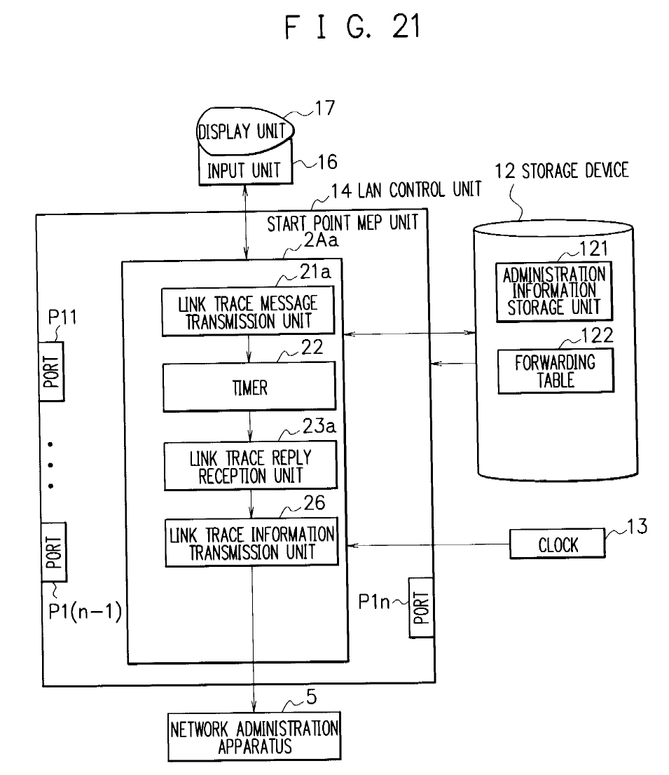

FIG. 20 is a block diagram showing an exemplary general configuration of the operation and administration system. Start point nodes 1-1 to 1-N in a plurality of monitored sections K1 to KN are connected to a network administration apparatus 5. Each of the start point nodes 1-1 to 1-N is provided with a start point MEP unit (shown in FIG. 21).

Each of the start point nodes 1-1 to 1-N has almost the same configuration as the start point node 1A shown in FIG. 3 but differs in that each node includes a start point MEP unit 2Aa having the configuration shown in FIG. 21 in place of the start point MEP unit 2A, and that the storage device 12 is not provided with the link trace database.

The start point MEP unit 2Aa shown in FIG. 21 differs from the start point MEP unit 2A shown in FIG. 7 in that the unit 2As includes a link trace message transmission unit 21a in place of the link trace message transmission unit 21, a link trace reply reception unit 23a in place of the link trace reply reception unit 23, and a link trace information transmission unit 26.

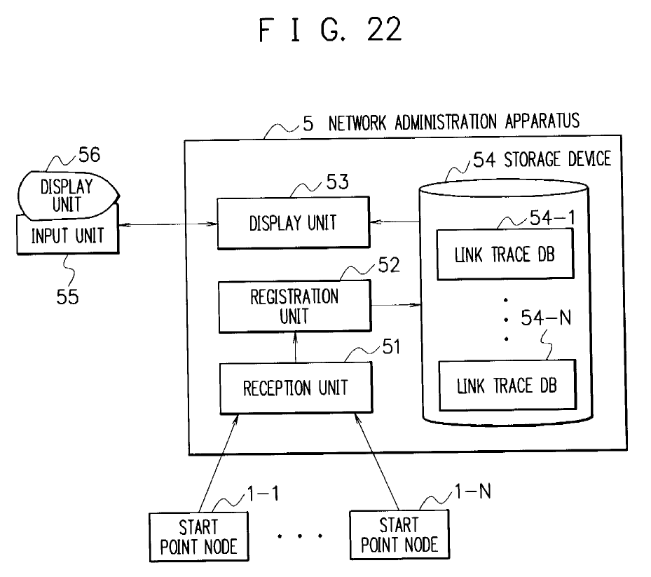

FIG. 22 is a block diagram showing an exemplary configuration of the network administration apparatus 5, which includes a reception unit 51, a registration unit 52, a display unit 53, a storage device 54, an input unit 55 such as a keyboard, and a display unit 56 such as an LCD.

The storage device 54 includes link trace databases 54-1 to 54-N for the start point MEP units provided in the start point nodes 1-1 to 1-N.

### <Operations>

Now, operations in this embodiment will be described. The following description will be given to different points from the first exemplary embodiment.

When the link trace message transmission unit 21a on the start point node 1-1 is activated, the unit 21a performs the processing shown in the flowchart of FIG. 12. However, the processing in step S125 is not performed in this embodiment because the link trace information analysis unit 25 does not exist.

When the link trace reply reception unit 23a receives a link trace reply from the LAN control unit 14, the unit 23a performs the processing shown in the flowchart of FIG. 16. However, the link trace reply reception unit 23a performs the following processing instead of step S166.

First, link trace information is generated that includes the current time input in step S163, the source ID and MAC address extracted in step S164, and the distance computed in step S165. Then, an identifier (assumed to be MEP 1) of its own start point MEP unit 2Aa is added to the generated link trace information, which is passed to the link trace information transmission unit 26. This is the processing performed instead of step S166.

The link trace information transmission unit 26 transmits the link trace information with the identifier “MEP 1” of the start point MEP unit 2Aa added thereto to the network administration apparatus 5.

The link trace information with the identifier “MEP 1” added thereto is received by the reception unit 51 in the network administration apparatus 5 and passed to the registration unit 52.

According to the link trace information passed from the reception unit 51, the registration unit 52 updates relevant link trace information registered in the link trace database 54-1 corresponding to the identifier “MEP 1” added to the link trace information. That is, a piece of link trace information with the same ID as the link trace information passed from the reception unit 51 among the pieces of link trace information registered in the link trace database 54-1 is processed so that the reception time in that piece of link trace information is updated to the reception time in the link trace information passed from the reception unit 51.

The display unit 53 displays the content of the link trace databases 54-1 to 54-N on the display unit 56 under the instruction of the administrator.

### <Advantages>

This embodiment provides an advantage to simplify the configuration of the nodes. This is because the network administration apparatus 5 is provided with the link trace databases 54-1 to 54-N in which the link trace information is registered.

The control operations in the above-described embodiments may be performed by hardware, software, or a combination of hardware and software.

If the processing is performed by software, a program describing a processing sequence may be installed into memory of a computer incorporated in special-purpose hardware and executed, or may be installed into a general-purpose computer capable of performing various kinds of processing and executed.

For example, the program may be recorded in advance on a computer-readable medium such as a hard disk or ROM (Read Only Memory).

Alternatively, the program may be temporarily or permanently stored (recorded) on a removable recording medium such as a floppy disk, CD-ROM (Compact Disc Read Only Memory), MO (Magneto Optical) disc, DVD (Digital Versatile Disc), magnetic disc, or semiconductor memory.

Such a removable recording medium may be provided as so-called package software.

Besides being installed from the above-described removable recording medium into the computer, the program may be transferred from a downloading site to the computer through wireless transfer or through wired transfer via a network such as a LAN (Local Area Network) or the Internet. At the computer, the transferred program may be received and installed onto a recording medium such as an internal hard disk.

The program may be structured to be executed not only sequentially according to the processing operations described in the above embodiments but also in parallel or individually, depending on processing capabilities of an apparatus performing the processing or as needed.

The operation and administration system described in the above embodiments may be configured as a logical aggregation of a plurality of apparatuses or may be constructed with mixed functions of a plurality of apparatuses.

The present invention is applicable to operation and administration systems for networks such as an Ethernet network.

According to the foregoing description of the exemplary embodiments, the present invention has the following features.

An operation and administration system as a first aspect of the present invention may be characterized in that a start point node serving as a start point of an administered section includes:

a link trace database having registered therein pieces of link trace information each including a source ID indicating a source of a link trace reply and a reception time of the link trace reply; and

a start point termination function unit that transmits a link trace message to an end point termination function unit on an end point node serving as an end point of the administered section in a predetermined cycle and, upon receiving a link trace reply to the transmitted link trace message, performs processing of updating the reception time to a current time for a piece of link trace information with the source ID indicating a source of the received link trace reply among the pieces of link trace information registered in the link trace database,

each intermediate node existing on a transfer route of the link trace message from the start point node to the end point node includes

an intermediate function unit that transmits a link trace reply to the received link trace message to the start point termination function unit and transmits the received link trace message to a next node on the transfer route, and

the end point node includes

the end point termination function unit that transmits a link trace reply to the received link trace message to the start point termination function unit.

In the above operation and administration system, the intermediate function unit may transmit the link trace reply containing an ID of the intermediate function unit itself as a source ID and a predefined value as a Time To Live to the start point termination function unit,

the end point termination function unit transmits the link trace reply containing an ID of the termination function unit itself as a source ID and the predefined value as the Time To Live to the start point termination function unit,

each piece of link trace information registered in the link trace database includes a distance to a source of a link trace reply in addition to the source ID and the reception time, and

the start point termination function unit includes:

a link trace message transmission unit that transmits the link trace message to the end point termination function unit in the predetermined cycle; and

a link trace reply reception unit that, upon receiving a link trace reply to the link trace message transmitted by the link trace message transmission unit, computes a distance to a source of the link trace reply based on the Time To Live in the received link trace reply and further retrieves a piece of link trace information with the same source ID as a source ID in the received link trace reply from the link trace database to update the reception time and the distance in the retrieved piece of link trace information to the current time and the computed distance.

In the above operation and administration system, it is preferable that

the start point termination function unit includes a timer that times out upon a lapse of predetermined time after being started,

the link trace message transmission unit starts the timer when transmitting the link trace message, and

the link trace reply reception unit discards a link trace reply received during timeout of the timer.

In the above operation and administration system, it is preferable that

the start point termination function unit includes

a link trace information analysis unit that detects an occurrence of a failure in the administered section and locates the failure based on the link trace information registered in the link trace database.

In the above operation and administration system, it is preferable that

the link trace information analysis unit determines the occurrence of the failure in the administered section if, after a lapse of the predetermined time from the transmission of the link trace message by the link trace message transmission unit, a piece of link trace information with the reception time earlier than a transmission time of the link trace message exists in the link trace information registered in the link trace database.

In the above operation and administration system, it is preferable that

if the occurrence of the failure in the administered section is determined, the link trace information analysis unit determines that the failure has occurred between an intermediate function unit or the end point termination function unit identified from a source ID in a piece of link trace information with the shortest distance among pieces of link trace information with the reception times earlier than the transmission time and an intermediate function unit identified from a source ID in a piece of link trace information with the longest distance among pieces of link trace information with the reception times later than the transmission time.

An operation and administration system may be characterized in that

a network administration apparatus includes:

a link trace database having registered therein pieces of link trace information each including a source ID indicating a source of a link trace reply and a reception time of the link trace reply; and

registration unit that, when link trace information including a source ID of a link trace reply and a reception time of the link trace reply is received from a start point termination function unit, processes a piece of link trace information with the same ID as the source ID in the received link trace reply among the pieces of link trace information registered in the link trace database to update the reception time to the reception time included in the received link trace information,

a start point node serving as a start point of an administered section includes

the start point termination function unit that transmits a link trace message to an end point termination function unit on an end point node serving as an end point of the administered section in a predetermined cycle and, upon receiving a link trace reply to the transmitted link trace message, transmits link trace information including a source ID and a reception time of the link trace reply to the network administration apparatus,

each intermediate node existing on a transfer route of the link trace message from the start point node to the end point node includes

an intermediate function unit that transmits a link trace reply to the received link trace message to the start point termination function unit and transmits the received link trace message to a next node on the transfer route, and

the end point node includes

the end point termination function unit that transmits a link trace reply to the received link trace message to the start point termination function unit.

A node may be

a node serving as a start point of an administered section, characterized by comprising:

a link trace database having registered therein pieces of link trace information each including a source ID indicating a source of a link trace reply and a reception time of the link trace reply; and

a start point termination function unit that transmits a link trace message to an end point termination function unit on an end point node serving as an end point of the administered section in a predetermined cycle and, upon receiving a link trace reply to the transmitted link trace message from the end point termination function unit or an intermediate function unit provided in an intermediate node existing on a transfer route of the link trace message from the node itself to the end point node, performs processing of updating the reception time to a current time for a piece of link trace information with the source ID indicating a source of the received link trace reply among the pieces of link trace information registered in the link trace database.

In the above node, it is preferable that

the link trace reply transmitted from the intermediate function unit contains an ID of the intermediate function unit as a source ID and a predefined value as a Time To Live,

the link trace reply transmitted from the end point termination function unit contains an ID of the termination function unit as a source ID and the predefined value as the Time To Live,

each piece of link trace information registered in the link trace database includes a distance to a source of a link trace reply in addition to the source ID and the reception time, and

the start point termination function unit includes:

a link trace message transmission unit that transmits the link trace message to the end point termination function unit in the predetermined cycle; and

a link trace reply reception unit that, upon receiving a link trace reply to the link trace message transmitted by the link trace message transmission unit, computes a distance to a source of the link trace reply based on the Time To Live in the received link trace reply and further retrieves a piece of link trace information with the same source ID as a source ID in the received link trace reply from the link trace database to update the reception time and the distance in the retrieved piece of link trace information to the current time and the computed distance.

In the above node, it is preferable that

the start point termination function unit includes a timer that times out upon a lapse of predetermined time after being started,

the link trace message transmission unit starts the timer when transmitting the link trace message, and

the link trace reply reception unit discards a link trace reply received during timeout of the timer.

In the above node, it is preferable that

the start point termination function unit includes

link trace information analysis unit that detects an occurrence of a failure in the administered section and locates the failure based on the link trace information registered in the link trace database.

In the above node, it is preferable that

the link trace information analysis unit determines the occurrence of the failure in the administered section if, after a lapse of the predetermined time from the transmission of the link trace message by the link trace message transmission unit, a piece of link trace information with the reception time earlier than a transmission time of the link trace message exists in the link trace information registered in the link trace database.

In the above node, it is preferable that

if the occurrence of the failure in the administered section is determined, the link trace information analysis unit determines that the failure has occurred between an intermediate function unit or the end point termination function unit identified from a source ID in a piece of link trace information with the shortest distance among pieces of link trace information with the reception times earlier than the transmission time and an intermediate function unit identified from a source ID in a piece of link trace information with the longest distance among pieces of link trace information with the reception times later than the transmission time.

An operation and administration method may be characterized by comprising the steps of:

transmitting a link trace message by a start point termination function unit on a start point node serving as a start point of an administered section to an end point termination function unit on an end point node serving as an end point of the administered section in a predetermined cycle;

transmitting, by an intermediate function unit provided in an intermediate node existing on a transfer route of the link trace message from the start point node to the end point node, a link trace reply to the received link trace message to the start point termination function unit;

transmitting the received link trace message by the intermediate function unit to a next node on the transfer route;

transmitting a link trace reply to the received link trace message by the end point termination function unit to the start point termination function unit; and

upon receiving a link trace reply to the transmitted link trace message, retrieving, by the start point termination function unit, a piece of link trace information with a source ID indicating a source of the link trace reply from a link trace database, and updating a reception time in the retrieved piece of link trace information to a current time, the link trace database having stored therein pieces of link trace information each including a source ID indicating a source of a link trace reply and a reception time of the link trace reply.

A program in a computer-readable medium may be characterized by causing a computer provided with a link trace database having registered therein pieces of link trace information each including a source ID indicating a source of a link trace reply and a reception time of the link trace reply to function as

a start point termination function unit that transmits a link trace message to an end point termination function unit on an end point node serving as an end point of an administered section in a predetermined cycle and, upon receiving a link trace reply to the transmitted link trace message from the end point termination function unit or an intermediate function unit provided in an intermediate node existing on a transfer route of the link trace message, performs processing of updating the reception time to a current time for a piece of link trace information with the source ID indicating a source of the received link trace reply among the pieces of link trace information registered in the link trace database.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An operation and administration system, wherein
a start point node serving as a start point of an administered section comprises:
a link trace database having registered therein pieces of link trace information each including a source ID indicating a source of a link trace reply and a reception time of the link trace reply; and
a start point termination function unit that transmits a link trace message to an end point termination function unit on an end point node serving as an end point of the administered section in a predetermined cycle and, upon receiving a link trace reply to the transmitted link trace message, performs processing of updating the reception time to a current time for a piece of link trace information with the source ID indicating a source of the received link trace reply among the pieces of link trace information registered in the link trace database,
each intermediate node existing on a transfer route of the link trace message from the start point node to the end point node comprises
an intermediate function unit that transmits a link trace reply to the received link trace message to the start point termination function unit and transmits the received link trace message to a next node on the transfer route, and
the end point node comprises
the end point termination function unit that transmits a link trace reply to the received link trace message to the start point termination function unit.

2. The operation and administration system according to claim 1, wherein
the intermediate function unit transmits the link trace reply containing an ID of the intermediate function unit itself as a source ID and a predefined value as a Time To Live to the start point termination function unit,
the end point termination function unit transmits the link trace reply containing an ID of the termination function unit itself as a source ID and the predefined value as the Time To Live to the start point termination function unit,
each piece of link trace information registered in the link trace database includes a distance to a source of a link trace reply in addition to the source ID and the reception time, and
the start point termination function unit comprises:
a link trace message transmission unit that transmits the link trace message to the end point termination function unit in the predetermined cycle; and
a link trace reply reception unit that, upon receiving a link trace reply to the link trace message transmitted by the link trace message transmission unit, computes a distance to a source of the link trace reply based on the Time To Live in the received link trace reply and further retrieves a piece of link trace information with the same source ID as a source ID in the received link trace reply from the link trace database to update the reception time and the distance in the retrieved piece of link trace information to the current time and the computed distance.

3. The operation and administration system according to claim 2, wherein
the start point termination function unit comprises a timer that times out upon a lapse of predetermined time after being started,
the link trace message transmission unit starts the timer when transmitting the link trace message, and
the link trace reply reception unit discards a link trace reply received during timeout of the timer.

4. The operation and administration system according to claim 2, wherein
the start point termination function unit comprises
a link trace information analysis unit that detects an occurrence of a failure in the administered section and locates the failure based on the link trace information registered in the link trace database.

5. The operation and administration system according to claim 4, wherein
the link trace information analysis unit determines the occurrence of the failure in the administered section if, after a lapse of the predetermined time from the transmission of the link trace message by the link trace message transmission unit, a piece of link trace information with the reception time earlier than a transmission time of the link trace message exists in the link trace information registered in the link trace database.

6. The operation and administration system according to claim 5, wherein
if the occurrence of the failure in the administered section is determined, the link trace information analysis unit determines that the failure has occurred between an intermediate function unit or the end point termination function unit identified from a source ID in a piece of link trace information with the shortest distance among pieces of link trace information with the reception times earlier than the transmission time and an intermediate function unit identified from a source ID in a piece of link trace information with the longest distance among pieces of link trace information with the reception times later than the transmission time.

7. An operation and administration system, wherein
a network administration apparatus comprises:
a link trace database having registered therein pieces of link trace information each including a source ID indicating a source of a link trace reply and a reception time of the link trace reply; and
a registration unit that, when link trace information including a source ID of a link trace reply and a reception time of the link trace reply is received from a start point termination function unit, processes a piece of link trace information with the same ID as the source ID in the received link trace reply among the pieces of link trace information registered in the link trace database to update the reception time to the reception time included in the received link trace information,
a start point node serving as a start point of an administered section comprises
the start point termination function unit that transmits a link trace message to an end point termination function unit on an end point node serving as an end point of the administered section in a predetermined cycle and, upon receiving a link trace reply to the transmitted link trace message, transmits link trace information including a source ID and a reception time of the link trace reply to the network administration apparatus,
each intermediate node existing on a transfer route of the link trace message from the start point node to the end point node comprises
an intermediate function unit that transmits a link trace reply to the received link trace message to the start point termination function unit and transmits the received link trace message to a next node on the transfer route, and
the end point node comprises
the end point termination function unit that transmits a link trace reply to the received link trace message to the start point termination function unit.

8. A node serving as a start point of an administered section, comprising:
a link trace database having registered therein pieces of link trace information each including a source ID indicating a source of a link trace reply and a reception time of the link trace reply; and
a start point termination function unit that transmits a link trace message to an end point termination function unit on an end point node serving as an end point of the administered section in a predetermined cycle and, upon receiving a link trace reply to the transmitted link trace message from the end point termination function unit or an intermediate function unit provided in an intermediate node existing on a transfer route of the link trace message from the node itself to the end point node, performs processing of updating the reception time to a current time for a piece of link trace information with the source ID indicating a source of the received link trace reply among the pieces of link trace information registered in the link trace database.

9. The node according to claim 8, wherein
the link trace reply transmitted from the intermediate function unit contains an ID of the intermediate function unit as a source ID and a predefined value as a Time To Live,
the link trace reply transmitted from the end point termination function unit contains an ID of the termination function unit as a source ID and the predefined value as the Time To Live,
each piece of link trace information registered in the link trace database includes a distance to a source of a link trace reply in addition to the source ID and the reception time, and
the start point termination function unit comprises:
a link trace message transmission unit that transmits the link trace message to the end point termination function unit in the predetermined cycle; and
a link trace reply reception unit that, upon receiving a link trace reply to the link trace message transmitted by the link trace message transmission unit, computes a distance to a source of the link trace reply based on the Time To Live in the received link trace reply and further retrieves a piece of link trace information with the same source ID as a source ID in the received link trace reply from the link trace database to update the reception time and the distance in the retrieved piece of link trace information to the current time and the computed distance.

10. The node according to claim 9, wherein
the start point termination function unit comprises a timer that times out upon a lapse of predetermined time after being started,
the link trace message transmission unit starts the timer when transmitting the link trace message, and
the link trace reply reception unit discards a link trace reply received during timeout of the timer.

11. The node according to claim 9, wherein
the start point termination function unit comprises
a link trace information analysis unit that detects an occurrence of a failure in the administered section and locates the failure based on the link trace information registered in the link trace database.

12. The node according to claim 11, wherein
the link trace information analysis unit determines the occurrence of the failure in the administered section if, after a lapse of the predetermined time from the transmission of the link trace message by the link trace message transmission unit, a piece of link trace information with the reception time earlier than a transmission time of the link trace message exists in the link trace information registered in the link trace database.

13. The node according to claim 12, wherein
if the occurrence of the failure in the administered section is determined, the link trace information analysis unit determines that the failure has occurred between an intermediate function unit or the end point termination function unit identified from a source ID in a piece of link trace information with the shortest distance among pieces of link trace information with the reception times earlier than the transmission time and an intermediate function unit identified from a source ID in a piece of link trace information with the longest distance among pieces of link trace information with the reception times later than the transmission time.

14. An operation and administration method comprising the steps of:
transmitting a link trace message by a start point termination function unit on a start point node serving as a start point of an administered section to an end point termination function unit on an end point node serving as an end point of the administered section in a predetermined cycle;
transmitting, by an intermediate function unit provided in an intermediate node existing on a transfer route of the link trace message from the start point node to the end point node, a link trace reply to the received link trace message to the start point termination function unit;
transmitting the received link trace message by the intermediate function unit to a next node on the transfer route;
transmitting a link trace reply to the received link trace message by the end point termination function unit to the start point termination function unit; and
upon receiving a link trace reply to the transmitted link trace message, retrieving, by the start point termination function unit, a piece of link trace information with a source ID indicating a source of the link trace reply from a link trace database, and updating a reception time in the retrieved piece of link trace information to a current time, the link trace database having stored therein pieces of link trace information each including a source ID indicating a source of a link trace reply and a reception time of the link trace reply.

15. A program in a computer-readable medium causing a computer provided with a link trace database having registered therein pieces of link trace information each including a source ID indicating a source of a link trace reply and a reception time of the link trace reply to function as
a start point termination function unit that transmits a link trace message to an end point termination function unit on an end point node serving as an end point of an administered section in a predetermined cycle and, upon receiving a link trace reply to the transmitted link trace message from the end point termination function unit or an intermediate function unit provided in an intermediate node existing on a transfer route of the link trace message, performs processing of updating the reception time to a current time for a piece of link trace information with the source ID indicating a source of the received link trace reply among the pieces of link trace information registered in the link trace database.
